(19) United States
(12) Patent Application Publication
(10) Pub. No.: US 2018/0311840 A1
(43) Pub. Date: Nov. 1, 2018

(54) SAFETY KNIFE APPARATUS AND METHOD

(71) Applicant: Thomas Richard Korin, Princeton, MN (US)

(72) Inventor: Thomas Richard Korin, Princeton, MN (US)

(21) Appl. No.: 15/903,457

(22) Filed: Feb. 23, 2018

Related U.S. Application Data
(60) Provisional application No. 62/462,440, filed on Feb. 23, 2017.

(51) Int. Cl. B26B 5/00

(52) U.S. Cl. CPC B26B 5/003

(57) ABSTRACT

A safety knife includes a sleeve having at least one grip opening therein. A shaft for holding the blade is positioned within the sleeve. The blade is movable between an deployed position and a retracted position with respect to the sleeve. When in the deployed position, a knurled surface is presented at the at least one grip opening. A spring is attached between the shaft and the sleeve. The spring is positioned to retract the blade to a retracted position when a grip on the knurled portion is released.

### TECHNICAL FIELD

Various embodiments described herein relate to an apparatus for a safety knife and to a method of making and using the same.

### BACKGROUND

Knives and sharps are inherently dangerous. Still, they are commonly used on a daily basis. Not only are knives and sharps used in homes, they are also used in industry. Knives and sharps have many uses in many industries. For example, knives are used for food preparation. Smaller knives, such as a hobby knife, are also used in industry. For example, in several industries, a manufacturer offers several models of an electrical device. In some industries, each model is made with separate components. A more cost effective approach uses a universal circuit board for every model. An unmodified circuit board will provide a maximum feature set and will command the largest price. Other models will have less than all the features of the top of the line model. In these cases, the circuit board is designed so that features are compartmentalized. In other words, the circuit board for controlling the product is made with traces that can be cut with an Exacto-type knife to remove several features. Cutting the line on the circuit board reduces the features for a lower priced model. As a result, manufacturers can easily offer several models since they do not have to have separate manufacturing for each model. A full featured unit is produced and the lines or traces are cut to reduce the features. It also saves cost in that only one part has to be designed and manufactured. The same part, namely a circuit board, can be used for each model and modified depending on the level of features ordered. Of course the traces on a circuit board are not large so a small knife, such as an Exacto type knife is used to make the precise cut to remove features.

As mentioned previously, Exacto type knives are inherently dangerous. If workers use any knife, such as an Exacto knife, in an unsafe manner, there is a high risk for an on the job accident. Workers can also get careless as they become more comfortable using an Exacto knife. Carelessness also leads to accidents on the job. Such an accident can result in a laceration. If stiches are required, reporting is triggered in many industries. Other lacerations can result in lost time at work. Accidents, therefore, are costly for many reasons. Health bills, law suits, lost time at work for the worker and lost time at work for the management in dealing with such accidents are only a few of the reasons such accidents are costly. Of course, if the Occupational Safety and Health Administration (“OSHA”) determines that the workplace is unsafe, fines and penalties can add to the cost. The Occupational Safety and Health Administration (“OSHA”) reported that over half of the nearly 3.0 million private industry injury and illness cases reported in 2014 involved days away from work, job transfer, or restriction. These cases occurred at a rate of 1.7 cases per 100 full-time workers, unchanged from 2013. Other recordable cases—those not involving days away from work or days of job transfer or restriction—accounted for the remaining nearly 1.4 million injury and illness cases in 2014. The rate of injuries and illnesses remained highest among mid-size private industry establishments (employing 50 to 249 workers) and lowest among small establishments (employing fewer than 11 workers).

OSHA has placed age restrictions on who can use knives and sharps. For example, in the 1970's, OSHA placed age restrictions on who could use knives and sharps. Additional OSHA regulations require appropriate hand protection for tools that can cause severe cuts or lacerations. Several regulations are set forth below.
General requirements. Employers shall select and require employees to use appropriate hand protection when employees' hands are exposed to hazards such as those from skin absorption of harmful substances; severe cuts or lacerations; severe abrasions; punctures; chemical burns; thermal burns; and harmful temperature extremes. [29 CFR 1910.138(a)]
Selection. Employers shall base the selection of the appropriate hand protection on an evaluation of the performance characteristics of the hand protection relative to the task(s) to be performed, conditions present, duration of use, and the hazards and potential hazards identified. [29 CFR 1910.138(b)]

A number of designs of knife are known in which the blade of the knife can be retracted into the knife body when the knife is not in use. In most cases, the retraction of the blade into the knife body requires the user to operate a lever or slide mechanism in order to retract the blade. With such knifes there is a tendency for the blade to be left in its operative, exposed position for extended periods of time even when the knife is not in use. There is an increased risk that a user or passer-by may be injured. Of course, there is a need for a safer knife than those safety knives that can be moved between an exposed position and a retracted position.

### SUMMARY OF THE INVENTION

This invention relates to a safety knife intended to reduce the risk of accidents which occur when the blade of a knife is left in an exposed position. This invention relates to a safety knife adapted to prevent a cutting edge of a blade of the knife from injuring the user of the knife. One example of a use for the safety knife is for performing cutting functions or the like.

A safety knife includes a sleeve having at least one grip opening therein. A shaft for holding the blade is positioned within the sleeve. The blade is movable between an deployed position and a retracted position with respect to the sleeve. When in the deployed position, a knurled surface is presented at the at least one grip opening. A spring is attached between the shaft and the sleeve. The spring is positioned to retract the blade to a retracted position when a grip on the knurled portion is released.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is a view of a safety knife in use with the blade in an extended or deployed position, according to an example embodiment.

FIG. 2 is a side view of an assembled safety knife apparatus, according to another example embodiment.

FIG. 3 is a cross sectional view of an assembled safety knife apparatus along line 3-3 of FIG. 2, according to an embodiment of the invention.

FIG. 4A is a top view of a sleeve of the safety knife apparatus, according to an example embodiment.

FIG. 4B is an end view of a sleeve 400 of the safety knife apparatus 100, according to an example embodiment.

FIG. 4C is a side view of a sleeve of the safety knife apparatus, according to an example embodiment.

FIG. 4D is a flat pattern view of the opening shown in FIGS. 4A and 4B which shows relative positions of all portions of the opening with respect to one another, according to an example embodiment.

FIG. 5A is an end view of a cap which fits on the closed end of the safety knife, according to an example embodiment.

FIG. 5B is a cross-section view of a cap along line 5B-5B of FIG. 5A, according to an example embodiment.

FIG. 6A is a cross sectional view of a shaft which fits inside the sleeve, according to an example embodiment.

FIG. 6B is a detailed view of the circled portion of the shaft from FIG. 6A and which details an opening, according to an example embodiment.

FIG. 7A is an end view of collet that holds the knife blade, according to an example embodiment.

FIG. 7B is a side view of collet that holds the knife blade, according to an example embodiment.

FIG. 8A is an end view of a collet sleeve which fits on the end of the shaft of the safety knife, according to an example embodiment.

FIG. 8B is a cross-section view of a collet sleeve along line A-A of FIG. 8A, according to an example embodiment.

FIG. 8C is a cross-section view of a collet sleeve corresponding to the circle B of FIG. 8B, according to an example embodiment.

FIG. 9A is a side view of the spring, according to the example embodiment.

FIG. 9B is an end view of the spring shown in FIG. 9A, according to the example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

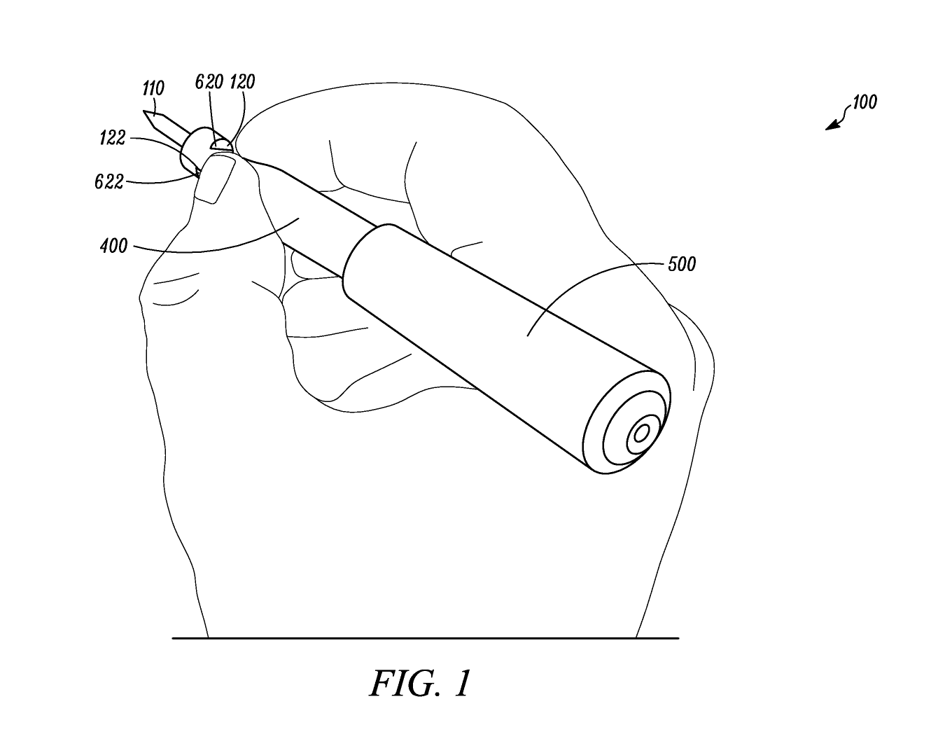

FIG. 1 is a view of a safety knife 100 in use with the blade 110 in an extended or deployed position, according to an example embodiment. FIG. 1B is a view of a safety knife after use with the blade in a retracted position, according to an example embodiment. Now referring to both FIGS. 1A and 1B, the safety blade will be further described. FIG. 1A shows the safety knife 100 in use by a person. The safety knife 100 is held through a set of handhold openings 120, 122 in a main body or sleeve 400 of the device. The user can hold the safety knife in an open position by gripping a knurled portion 620, 622 of a shaft 600 which passes through the body or sleeve 400 When the person releases the safety knife 100 or more specifically releases the grip on the knurled portions 620, 622, a blade 110 moves from its extended position to a retracted position within the main body or sleeve 400 of the device. This happens substantially automatically. A spring 900 (shown in FIGS. 3 and 9) acts both axially and torsionally. The spring 900 is positioned to so that it acts axially and pulls the shaft 600, the collet 700, the collet sleeve 800 and the blade from an extended position to the retracted position. The spring also acts torsionally to twist the shaft 600, and collet 700, and the blade 100 so that the flat portion of the blade 110 is presented at the handhold openings in the main body or sleeve 400 when in the retracted position, as shown in FIG. 3. Now referring to the remaining figures, the safety knife 100 will be further detailed.

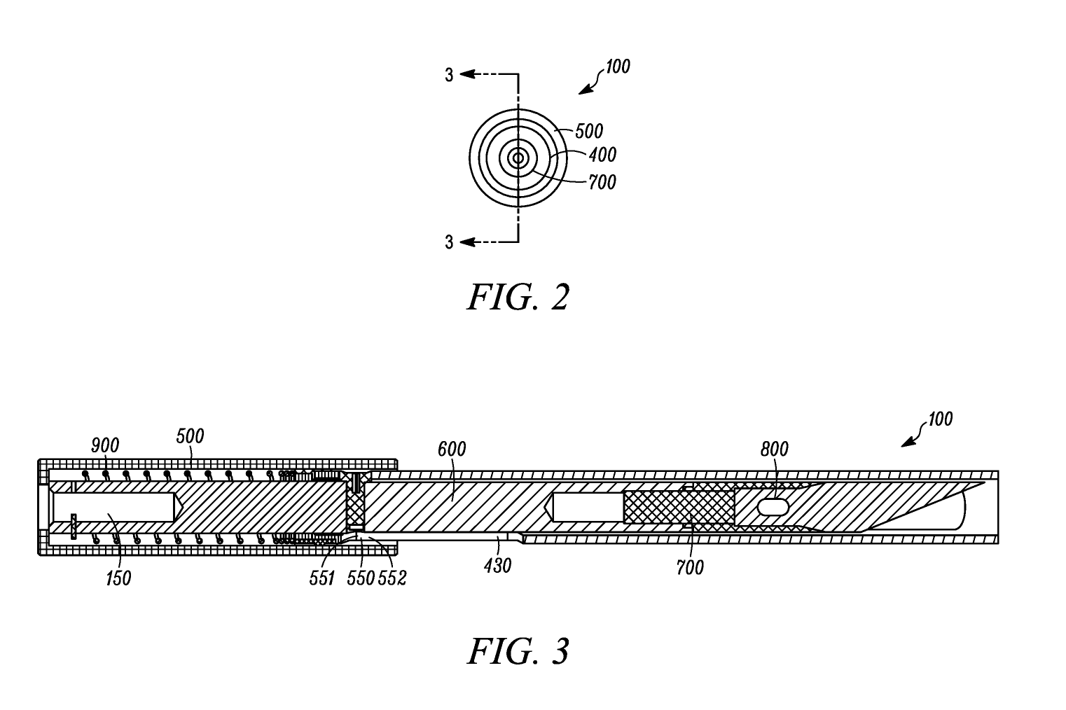

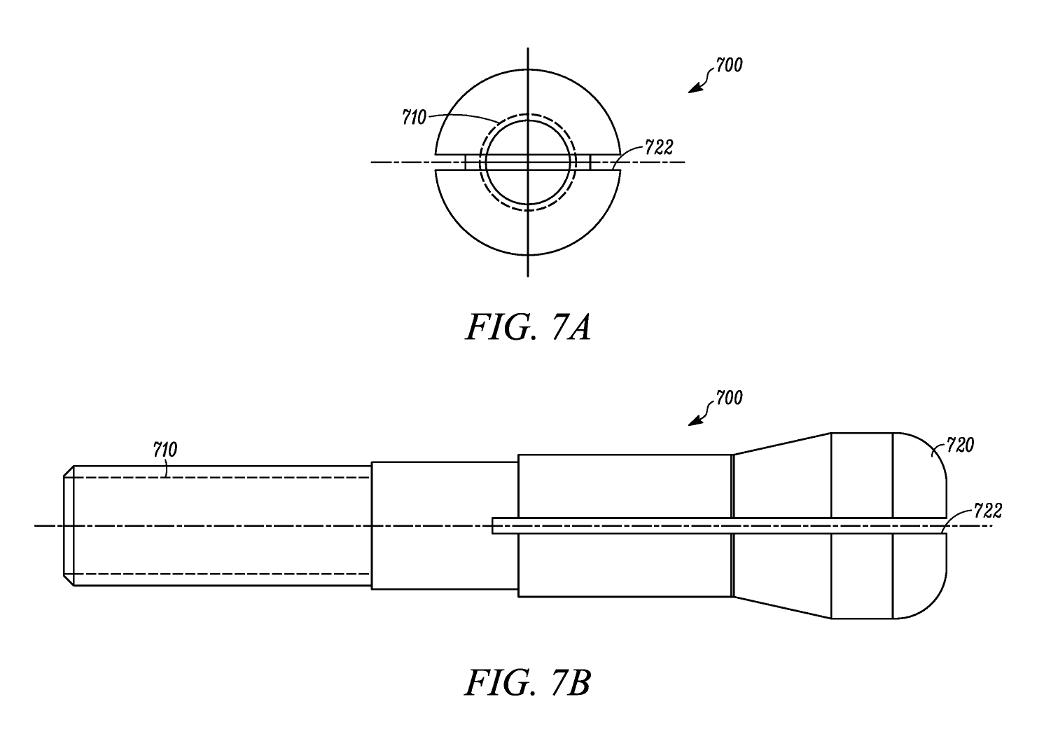

FIG. 2 is an end view of an assembled safety knife apparatus 100, according to an example embodiment. The end view shows a cap 500 slidably engaged with the housing or sleeve 400 of the safety knife 100. The end view also shows the collet 700 engaged with the shaft 600. The collet 700 has a bulbous end (see FIG. 7) which covers the view of the shaft 600, and the collet sleever 800. The collet 700 also hides the spring 900.

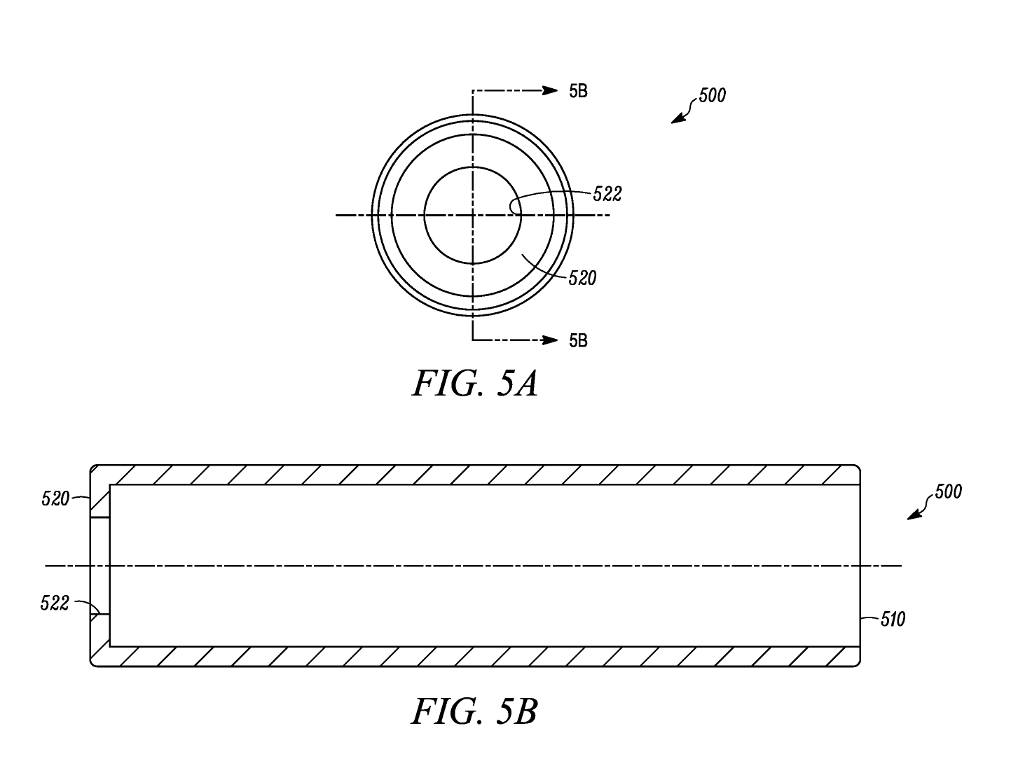

FIG. 3 is a cross sectional view of an assembled safety knife apparatus along line 3-3 of FIG. 2, according to an embodiment of the invention. As shown in FIG. 3, the safety knife 100 also includes a shaft 600, a collet 700, a collet sleeve 800 and a blade 110. The collet 700 holds the blade 110. The collet sleeve 800 is positioned to force the end of the collet 700 to place a gripping force onto the plate portion of the blade 110. The collet 700 fits into an opening 610 at one end of the shaft 600. As shown in FIG. 2, the shaft 600, the collet 700 the collet sleeve 800 fit within the sleeve 400 or main body of the safety knife apparatus 100. It should be noted that the safety knife 100 is shown in a retracted position in FIG. 3. The retracted position is the position the safety knife takes when no external forces are placed on the safety knife apparatus 100, such as when a knurled portion of the collet shaft 600 is held in a deployed position (shown in FIG. 1A). The cap 500 includes an opening 522 (see FIG. 5) which is sized to receive a fastener 150. The shaft 600 includes a second end 622 which has a threaded opening 623. The threaded opening 623 has an internal thread 630, 632 therein. The internal thread 630 of the first opening 620 is sized to receive the threaded end of the fastener 150. The cap 500 is attached to the shaft 600 with the fastener 150. When assembled, the cap 500 and the shaft 600 move together. The internal portion of the cap 500 moves over the exterior of the sleeve 400. The blade 110, collet 700, and collet sleeve 800 are attached to the first end of the shaft 620 and also move with the shaft 600 and the cap 500.

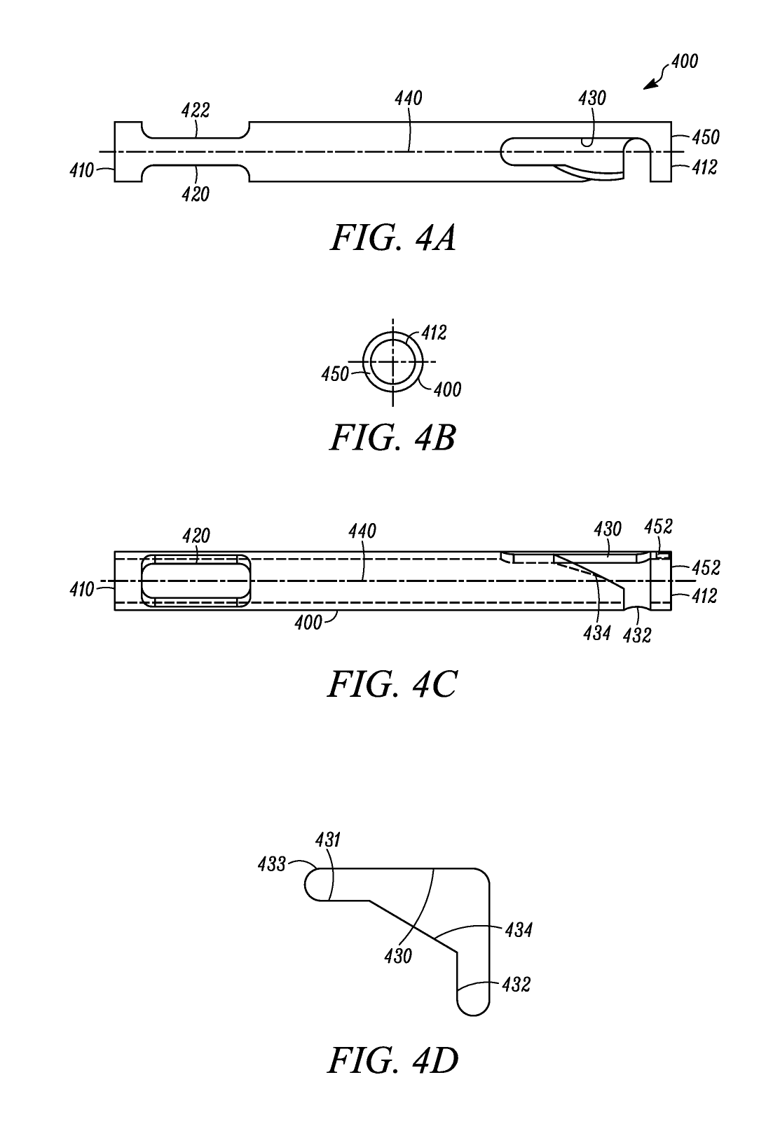

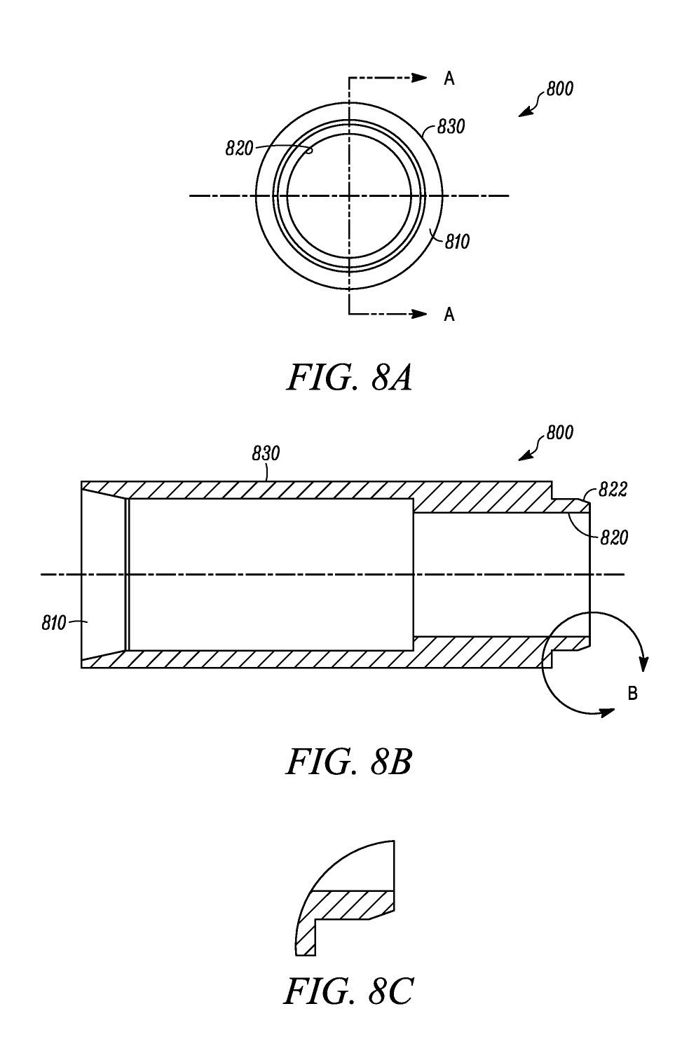

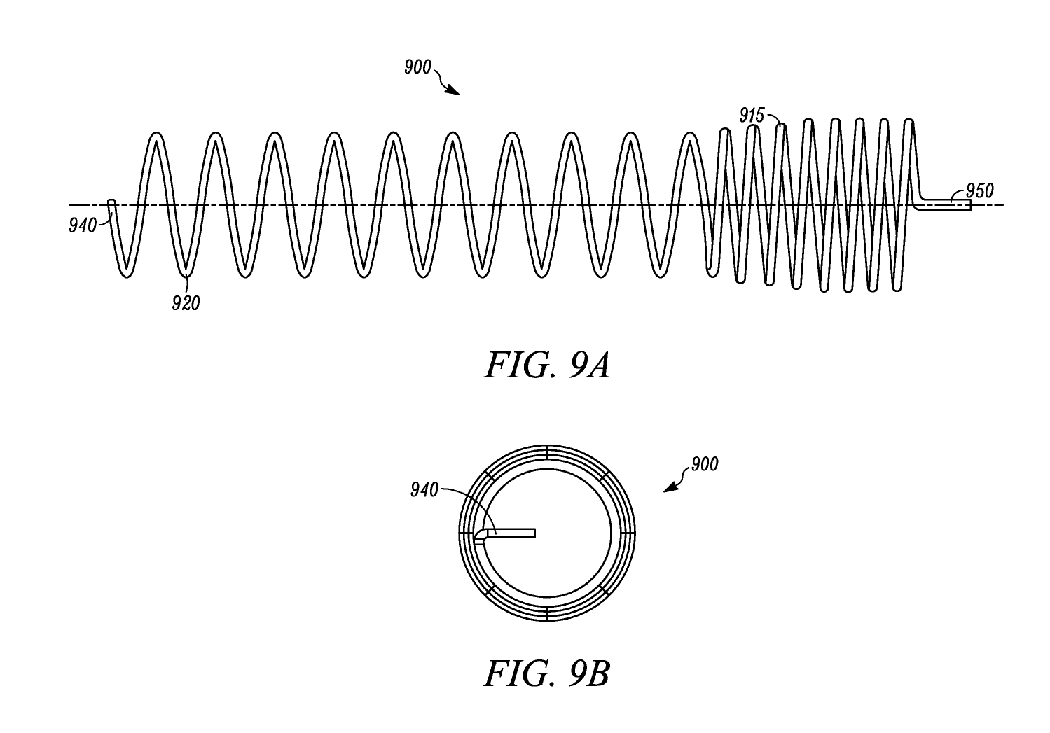

FIG. 4A is a top view of a sleeve 400 of the safety knife apparatus 100, according to an example embodiment. FIG. 4B is an end view of a sleeve 400 of the safety knife apparatus 100, according to an example embodiment. FIG. 4C is a side view of a sleeve 400 of the safety knife apparatus 100, according to an example embodiment. FIG. 4D is a flat pattern view of the cam opening in the sleeve 400 of the safety knife apparatus 100 shown in FIGS. 4A and 4C. The flat pattern view shows relative positions of all portions of the cam opening with respect to one another, according to an example embodiment. Now referring to FIGS. 4A, 4B, 4C and 4D, the sleeve 400 will be further detailed. The sleeve 400 is essentially tubular in shape and has a first open-end 410 and a second open-end 412. The first open-end 410 is the end where the blade 110 travels through to an extended position where the blade 110 is exposed and can be used as a cutting tool. The first open-end 410 is also the end into which the blade 110 is housed when the blade is in the retracted position. In other words, the blade 110 travels through the first open-end 410 during the operation of the safety blade 100. The sleeve 400 also includes a first grip opening 420 and a second grip opening 422. The first grip opening 420 in the second grip opening 422 are sized so that user's digits can grip a portion of the collet sleeve 800. When in the extended position the collet sleeve 800 includes a knurled portion (further detail below with respect to FIG. 8) which is typically gripped between the index finger and the thumb of a user. The sleeve 400 also includes a slot 430. The slot 430 includes a catch 432 and a cam surface 434. The free end 552 rides within the slot 430 including within the catch 432 and over the cam surface 434. The cam surface 434 controls the rotational position of the shaft 600 and the blade 110 as the pin 550 rides over the cam surface. as it passes between a retracted position and an extended position. In the extended position the safety blade 100 is ready for use.

The slot 430 is further detailed in FIG. 4D. FIG. 4D is a flat pattern view of the slot 430. The slot 430 includes a first portion 431 that is parallel to a central axis 440 of the tube or sleeve 400. The first portion 431 includes a start 433. The start 433 is the portion of the slot 430 which is closest to the open end 410 of the sleeve 400. The cam surface 434 is angled with respect to the first portion 431 of the slot 430. In one embodiment, the angle of the cam surface 434 with respect to the first portion 431 of the slot 430 is in the range of 15 to 45°. In another embodiment the range of the angle is 20 to 40°. Still a further embodiment the range of the angle is approximately 25 to 35°. Still further embodiment, the angle is approximately or substantially 30°. The cam surface 434 connects the first portion 431 of the slot 430 to the catch or catch portion 432 of the slot 430. The catch portion 432 is substantially perpendicular to the first portion 431 of the slot 430. The catch portion 432 is also substantially perpendicular to the axis 440 of the sleeve 400.

In the second open end 412 is an opening 450. The opening 450 is actually in the wall of the tubular sleeve 400. The opening 450 has an axis 452 which is parallel with the axis 440 of the sleeve 400. The opening 450 is timed to the start 433 of the slot 430. In other words, a line through the axis 452 of the opening 452 the start 433 of the slot 430 is parallel to the axis 440 of the sleeve 400. The opening 450 is dimensioned so as to receive a tang 950 of the spring 900. When the shaft 600 is moved forward or to an extended position, a projection on the shaft 600 rides over the cam surface 432 to the first portion 431 of the slot 430. The shaft 600 twists as it rides over the cam surface to move the blade 110 from a position at the grip openings 420, 422 where the flat surface of the blade is presented at the grip openings 420, 422 to a deployed or used position. More importantly, the shaft twists again as the blade is being retracted so that the flat surfaces of the blade 110 are present at the grip openings 420, 422 when the blade is moved from the deployed position to the retracted position. This makes the safety knife 100 much safer since the sharp edges of the blade are not presented at the grip openings 420, 422 when in the retracted position. When in a deployed position the collet sleeve and more specifically a knurled portion of the collet sleeve is presented at the grip openings 420, 422. The spring 900 acts axially to retract the shaft 600. The springs 900 also acts torsionally to rotate the shaft 600 so that the flat sides of the blade 110 are presented at the grip openings 420, 422. The spring 900 acts both axially and torsionally. The spring is positioned so that the default position is with the blade 110 and the shaft 600 in the retracted position with respect to the sleeve or main body 400. In other words, the spring 900 is at rest when the shaft 600 and blade 110 are in the retracted position. The spring 900 is twisted and extended when in the extended position. If the safety knife 100 is released when in the extended position, the spring 900 pulls the shaft and blade 110 to the retracted position. The spring also twists the blade 110 so that the flat surfaces of the blade are presented to the grip openings 420, 422.

FIG. 5A is an end view of a cap 500 which fits on the second end 412 of the sleeve 400 of the safety knife 100, according to an example embodiment. FIG. 5B is a cross-section view of a cap along line 5B-5B of FIG. 5A, according to an example embodiment. The cap 500 has an inner diameter which fits over the second and for 12 of the sleeve 400. The cap 500 includes an open end 510 and a partially closed and 520. The partially closed and 520 includes an opening 522. The opening 522 allows for access to the shaft 600 when the safety knife is assembled. In one embodiment, the open end 510 of the cap 500 is force fit over the open end of the sleeve 412. In another embodiment the open end 510 of the 500 is provided with a thread and the exterior portion of the sleeve 412 is also provided with a meeting thread.

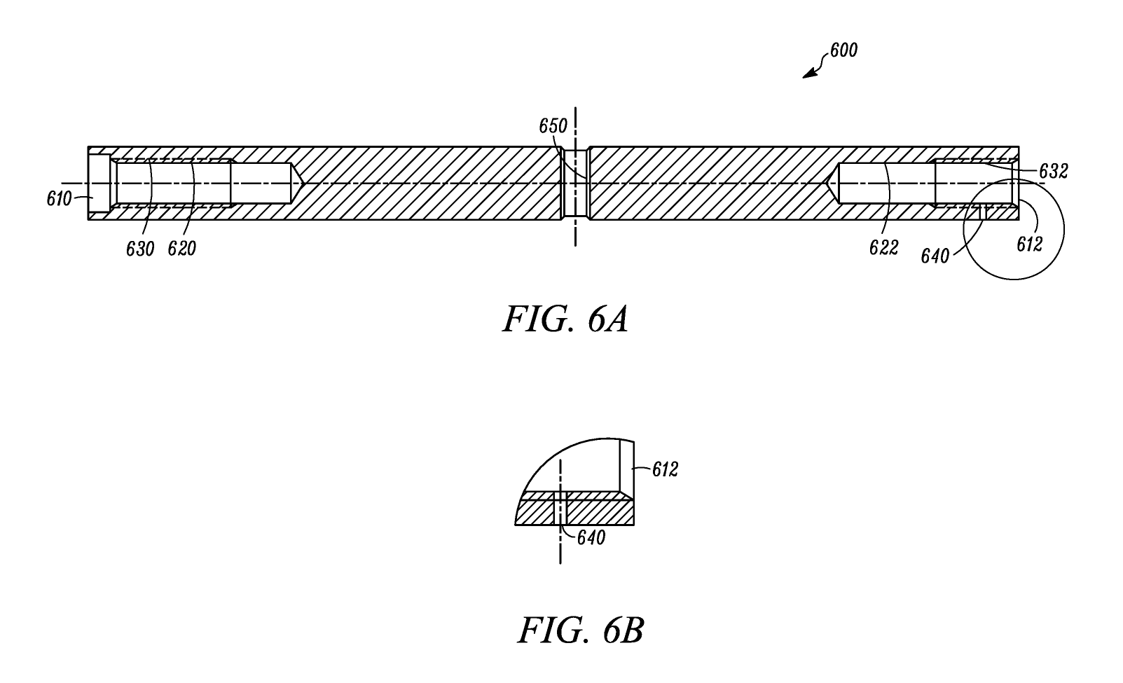

FIG. 6A is a cross sectional view of a shaft 600 which fits inside the sleeve 400, according to an example embodiment. FIG. 6B is a detailed view of the circled portion of the shaft 600 which details an opening 640, according to an example embodiment. Now turning to both FIGS. 6A and 6B, the shaft 600 will be described in further detail. The shaft 600 includes a first end 610 and a second end 612. The first end 610 includes an opening 620 which is sized to receive the collet 700. The second end 622 also includes an opening 622. The openings 620, 622 each have an internal thread 630, 632 therein. The internal thread 630 of the first opening 620 is sized to receive the threaded end of the collet 700. The collet 700, therefore fits in the first end 610 of the shaft 600. The opening 640 is a radial from the central axis of the shaft 600. The opening 640 receives a pin 644 which is sized to engage the slot 430 of the sleeve. The pin 644 is press fit into the opening 640 and projects out from the surface or exterior surface of the shaft 600 to a distance that engages the slot 630. During assembly the pin 644 is placed into the opening 640 after the shaft 600 is placed into the sleeve 400. The position of the opening 640 is timed to the position of the blade 110 in the collet 700 so that the flat portion or flat surfaces of the blade 110 are presented at the grip openings 420, 422 of the sleeve when the pin 644 is engaged with the catch portion 432 of the slot 430. The shaft 600 is also has a through opening 650 positioned about midway down the length of the shaft 600. The through opening 650 receives an other end of the spring 900. The through opening 650 is size so that a tang on the spring 900 fits into the through opening 650. The spring 900 fits between the shaft 600 and the internal portion of the sleeve 400. The size of the spring 900 allows it to move over the shaft 600 and over the interior surface of the sleeve 400 without binding. The cap 500 must be made very square or perpendicular with respect to the central axis of the shaft 600. The cap 500 thus prevents the shaft 600 from canting and binding as it slides within the sleeve 400.

FIG. 7A is an end view of collet 700 that holds the knife blade 110, according to an example embodiment. FIG. 7B is a side view of collet 700 that holds the knife blade 110, according to an example embodiment. The collet 700 includes a threaded end 710 and a mushroom-shaped end 720. The threaded end 710 engages the end 610 of the shaft 600. Specifically the threaded end 710 engages the thread 630 in opening 620. The mushroom-shaped end 720 includes a slit 722 therein. The slit 722 is large enough so that the non-cutting end of the blade 110 fits within the slit. The collet sleeve 800 is moved into position and forces the two sides of the mushroom-shaped and 720 toward one another to pinch the two sides of the blade 110 and hold it securely within the slit. In other words the collet sleeve 800 forces the two sides of the mushroom shaped and 722 toward one another at the slit which in turn pinches or otherwise holds the knife with respect to the collet 700.

FIG. 8A is an end view of a collet sleeve 800 which fits on the end 610 of the shaft 600 of the safety knife 100, according to an example embodiment. FIG. 8B is a cross-section view of a collet sleeve along line 8B-8B of FIG. 8A, according to an example embodiment. FIG. 8C is a cross-section view of a collet sleeve corresponding to the circle B of FIG. 8B, according to an example embodiment. The collet sleeve 800 includes a first end 810 and a second end 820. The first and 810 includes an internal chamfered portion 812. The internal chamfered portion 812 slides against the mushroom-shaped and 720 of the collet 700. As the internal chamfered portion 812 moves closer to the end 720 of the collet 700, the two separated portions of the mushroom-shaped end 720 are forced closer together and therefore produce a larger force at the slit 722 to hold a blade 110 more tightly within the slit 722. The end 820 also includes a chamfered portion 822 which fits within the opening 620 in the shaft 600. The chamfered portion 822 limits the amount of travel of the collet sleeve 800. The collet sleeve 800 also includes a knurled exterior portion 830. The knurled portion 830 allows the user or a user to more easily grip the collet sleeve. The collet sleeve 830 is positioned at the grip openings 420, 422 of the sleeve 400 when the safety knife is in the deployed position. The collet sleeve 830 can be turned or rotated to remove the blade or to tighten the blade with respect to the collet 700. The collet 700 and the collet sleeve 800 fit within the internal dimension of the sleeve 400 when in the retracted position.

FIG. 9A is a side view of the spring, according to the example embodiment. A spring includes a first open end that includes a tang, a second open end, a first series of spaced coils, and a second series of spaced coils having a different spacing than the first series of spaced coils. The first series of spaced coils is attached to the second series of spaced coils. The spring produces a first spring force in an axial direction and a second spring force acting in a radial direction. In another embodiment, the spring has tangs at both ends.

FIG. 9B is an end view of the spring 900, according to the example embodiment. The end view details tang 940 that extends in toward the axis shown in FIG. 9A.

A safety knife including a blade, a shaft, a sleeve and a spring. The shaft has a first end for holding a blade. The shaft also has a grip surface near the first end. The shaft includes a second end. The shaft is sized to move inside the sleeve and move within the sleeve. The blade is capable of a deployed position where the blade extends outside the sleeve and a retracted position where the blade is positioned within the sleeve. The sleeve has at least one grip opening therein where the grip surface of the shaft is positioned when the blade is in the deployed position. The spring is attached between the shaft and the sleeve. The spring is disposed to return the blade to a retracted position from the deployed position. The blade, when in the retracted position, is in a substantially non hazardous position. In another embodiment, the blade, when in the retracted position, is in a position where the major surface of the blade is positioned facing the at least one grip opening in the sleeve. The spring includes a tang at one end of the spring, the tang positioned within an opening in the sleeve. The spring is elongated when the blade is moved to a deployed position. The spring returns to a non elongated position to move the knife blade and shaft from the deployed position to the retracted position. In one embodiment, the sleeve has a cam opening therein. The cam opening includes a cam surface. The shaft includes a cam follower. The interaction of the cam follower with the cam surface causes the blade to rotate to a position where the major surface of the blade is positioned facing the at least one grip opening as the shaft and knife travel from a deployed position to the retracted position. In one embodiment, the cam follower is a pin attached to the shaft. The safety knife further includes a cap attached to the shaft. The cap travels over a portion of the outside surface of the sleeve when the shaft and blade travel between the retracted position and the deployed position and vice versa. In another embodiment, the cap substantially covers the cam opening and cam surface of the sleeve. The spring acts in both an axial direction and a radial direction when the shaft and knife travel between the deployed position and the retracted position. In one embodiment, the grip surface of the shaft includes knurling. In still another embodiment, the sleeve includes a first grip opening and a second grip opening sized to allow gripping of the grip surface of the shaft when the shaft and blade are in a deployed position.

A safety knife includes a blade, shaft, sleeve and spring. The shaft has a first end for holding a blade and a second end. The shaft further includes a grip surface near the first end, a cam follower near the second end, and a collet for holding the blade at the first end of the shaft. The shaft is sized to move inside the sleeve and move within the sleeve. The blade is capable of a deployed position where the blade extends outside the sleeve and a retracted position where the blade is positioned within the sleeve. The sleeve has at least two grip openings therein where the grip surface of the shaft is positioned substantially at the at least two grip openings when the blade is in the deployed position. The sleeve has a cam opening therein which includes a cam surface that engages the cam follower to move the blade to a position where the major surface of the blade is presented at the at least two grip openings when the blade and shaft are in the retracted position. The spring is attached between the shaft and the sleeve. The spring disposed to return the blade to a retracted position from the deployed position. The spring includes a tang at one end, and wherein the sleeve includes an opening for receiving the tang. In another embodiment, the spring includes a first tang at one end, and a second tang on the other end, wherein the sleeve includes an opening for receiving the first tang and the shaft includes an opening for receiving the second tang.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed:

1. A safety knife comprising:
a shaft having a first end for holding a blade and a second end, the shaft including a grip surface near the first end;
a sleeve, the shaft sized to move inside the sleeve and move within the sleeve, the blade capable of a deployed position where the blade extends outside the sleeve and a retracted position where the blade is positioned within the sleeve; the sleeve having at least one grip opening therein where the grip surface of the shaft is positioned when the blade is in the deployed position; and
a spring attached between the shaft and the sleeve, the spring disposed to return the blade to a retracted position from the deployed position.

2. The safety knife of claim 1 wherein the blade, when in the retracted position, is in a substantially non hazardous position.

3. The safety knife of claim 1 wherein the blade, when in the retracted position, is in a position where the major surface of the blade is positioned facing the at least one grip opening in the sleeve.

4. The safety knife of claim 1 wherein the spring includes a tang at one end of the spring, the tang positioned within an opening in the sleeve.

5. The safety knife of claim 1 wherein the spring is elongated when the blade is moved to a deployed position.

6. The safety knife of claim 5 wherein the spring returns to a non elongated position to move the knife blade and shaft from a deployed position to a retracted position.

7. The safety knife of claim 1, the sleeve having a cam opening therein, the cam opening including a cam surface.

8. The safety knife of claim 1 wherein the shaft includes a cam follower, the interaction of the cam follower with the cam surface causing the blade to rotate to a position where the major surface of the blade is positioned facing the at least one grip opening as the shaft and knife travel from a deployed position to the retracted position.

9. The safety knife of claim 8 wherein the cam follower is a pin attached to the shaft.

10. The safety knife of claim 8 further comprising a cap attached to the shaft, the cap traveling over a portion of the outside surface of the sleeve when the shaft and blade travel between the retracted position and the deployed position and vice versa.

11. The safety knife of claim 10 wherein the cap substantially covers the cam opening and cam surface of the sleeve.

12. The safety knife of claim 1 wherein the spring acts in both an axial direction and a radial direction when the shaft and knife travel between the deployed position and the retracted position.

13. The safety knife of claim 1 wherein the grip surface includes knurling.

14. The safety knife of claim 1 wherein the sleeve includes a first grip opening and a second grip opening sized to allow gripping of the grip surface of the shaft when the shaft and blade are in a deployed position.

15. A safety knife comprising:
a blade;
a shaft having a first end for holding a blade and a second end, the shaft further including
a grip surface near the first end;
a cam follower near the second end;
a collet for holding the blade at the first end of the shaft;
a sleeve, the shaft sized to move inside the sleeve and move within the sleeve, the blade capable of a deployed position where the blade extends outside the sleeve and a retracted position where the blade is positioned within the sleeve; the sleeve having at least two grip openings therein where the grip surface of the shaft is positioned substantially at the at least two grip openings when the blade is in the deployed position, the sleeve having a cam opening therein which includes a cam surface that engages the cam follower to move the blade to a position where the major surface of the blade is presented at the at least two grip openings when the blade and shaft are in the retracted position; and
a spring attached between the shaft and the sleeve, the spring disposed to return the blade to a retracted position from the deployed position.

16. The safety knife of claim 15 wherein the spring includes a tang at one end, and wherein the sleeve includes an opening for receiving the tang.

17. The safety knife of claim 15 wherein the spring includes a first tang at one end, and a second tang on the other end, wherein the sleeve includes an opening for receiving the first tang and the shaft includes an opening for receiving the second tang.

18. A spring including
an first open end that includes a tang;
a second open end;
a first series of spaced coils;
a second series of spaced coils having a different spacing than the first series of spaced coils, the first series of spaced coils attached to the second series of spaced coils, the spring producing a first spring force in an axial direction and a second spring force acting in a radial direction.
